(19) United States
(12) Patent Application Publication
(10) Pub. No.: US 2014/0204465 A1
(43) Pub. Date: Jul. 24, 2014

(54) HEAD-UP DISPLAY DEVICE

(71) Applicant: DENSO CORPORATION, Kariya-city (JP)

(72) Inventor: Masayuki Yamaguchi, Nagoya-city (JP)

(73) Assignee: DENSO CORPORATION, Kariya-city (JP)

(21) Appl. No.: 14/159,545

(22) Filed: Jan. 21, 2014

(30) Foreign Application Priority Data
Jan. 22, 2013 (JP) 2013-009501

(51) Int. Cl. G02B 27/01

(52) U.S. Cl. CPC G02B 27/0101
USPC 359/633

(57) ABSTRACT

A head-up display device includes a projector, a screen component and a prism component. The prism component integrally has an incidence surface into which laser light enters from the projector, a mirror surface which reflects the laser light entering inside the prism component from the incidence surface, and an exit surface which emits the laser light reflected by the mirror surface toward the screen component outside of the prism component, as optical surface on an optical path, and each of the incidence surface and the exit surface constructs a lens surface such that that the laser light is formed into an image relative to the screen component in a spot state.

### CROSS REFERENCE TO RELATED APPLICATION

This application is based on Japanese Patent Application No. 2013-9501 filed on Jan. 22, 2013, the disclosure of which is incorporated herein by reference in its entirety.

### TECHNICAL FIELD

The present disclosure relates to a head-up display device.

### BACKGROUND

A head-up display (HUD) device includes a projector which projects laser light on a screen component so as to display a display picture on a projection surface.

JP-2010-145745A describes such a laser type HUD device in which a lens is disposed in an optical path between a projector and a screen component, so that laser light irradiated to the screen component forms a clear image in a spot state.

However, it is necessary to secure the optical path between the projector and the screen component to have a straight line shape, the size of the HUD device becomes large as a whole. It is difficult to arrange a large-sized HUD device in a limited space of a movable unit such as car.

### SUMMARY

A mirror which reflects laser light is arranged between a projector and a screen component, together with a lens, so as to bend an optical path. The mirror and the lens are attached to a movable unit through an attachment component so as to dispose the mirror and the lens with appropriate position and orientation in the space between the projector and the screen component.

In this case, the number of components for producing a head-up display device is increased, and the assemblabililty is lowered.. Moreover, since it is necessary to arrange the attachment component in addition to the mirror and the lens between the projector and the screen component, the real distance between the projector and the screen component becomes long. In the latter case, since the numerical aperture becomes small between the projector and the screen component, the spot size of the laser light which is formed into an image on the screen component becomes large, so the effect improving the image formation performance will be restricted.

It is an object of the present disclosure to provide a small-size head-up display device having high assemblabililty and image formation performance.

According to an example of the present disclosure, a head-up display device that projects a display picture on a projection surface of a movable unit to display a virtual image of the display picture which is seen from an interior of the movable unit includes a projector, a screen component and a prism component. The projector projects laser light. The screen component produces the display picture to be projected on the projection surface by irradiating the laser light. The prism component is disposed on an optical path between the projector and the screen component and introduces and irradiates the laser light projected from the projector to the screen component. The prism component has a refractive index which is higher than that of air, and integrally has an incidence surface into which the laser light enters from the projector, a mirror surface which reflects the laser light entering inside the prism component from the incidence surface, and an exit surface which emits the laser light reflected by the mirror surface toward the screen component outside of the prism component. The incidence surface, the mirror surface and the exit surface correspond to optical surface on the optical path. Each of the incidence surface and the exit surface constructs a lens surface such that that laser light is formed into an image relative to the screen component in a spot state.

Accordingly, on the optical path between the projector and the screen component, the prism component which introduces the laser light from the projector to irradiate to the screen component integrally has the incidence surface and the exit surface, each of which constructs the lens surface, together with the mirror surface. Therefore, the optical path is bent by the reflex action of the mirror surface to reduce the size, and the image formation performance is improved by the incidence surface and the exit surface, due to the prism component, the number of components can be reduced and the assemblabililty to the movable unit can be improved.

Furthermore, the prism component has a refractive index which is higher than that of air. The laser light incident into the incidence surface from the projector is reflected inside the prism component by the mirror surface, and is emitted toward an external screen component from the exit surface. Therefore, relative to the real distance between the projector and the screen component, air- conversion-length inside the prism component is relatively shortened by the high refraction characteristic of the prism component. Thus, the numerical aperture between the projector and the screen component can be increased as much as possible. The increase in the numerical aperture may decrease the spot size of the laser light which is formed into an image on the screen component, so it also becomes possible to improve the image formation performance in a range according to the real distance defined between the projector and the screen component.

Further, when the numerical aperture between the projector and the screen component is defined as NA, when a projection diameter of the laser light projected by the projector is defined as φ, when an actual distance between the projector and the screen component is defined as D, when an actual distance between the incidence surface and the exit surface via the mirror surface inside of the prism component is defined as t, and when a refractive index of the prism component is defined as n, a relationship of NA=φ{2D−2t·(1−1/n)} is satisfied.

Therefore, the air-conversion-length inside the prism component can be shortened between the projector and the screen component by the actual distance t between the incidence surface and the exit surface via the mirror surface inside the prism component having high refractive index n. Accordingly, the numerical aperture NA expressed by the above relationship using the projection diameter of laser light can be increased in the range according to the actual distance D between the projector and the screen component, such that it becomes possible to improve the image formation performance certainly.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic view illustrating a head-up display device according to a first embodiment;

FIG. 2 is a schematic view displayed by the head-up display device;

FIG. 3 is a diagram illustrating the head-up display device;

FIG. 4 is a side view illustrating a prism component of the head-up display device;

FIG. 5 is a partial perspective view illustrating a screen component of the head-up display device;

FIG. 6 is a perspective view illustrating the prism component;

FIG. 7 is an explanatory view for explaining a numerical aperture of the head-up display device;

FIG. 8 is an explanatory view for explaining a numerical aperture of a comparative example

FIG. 9 is a side view illustrating a prism component of a head-up display device according to a second embodiment; and

FIG. 10 is a side view illustrating a prism component of a head-up display device according to a third embodiment.

### DETAILED DESCRIPTION

Embodiments of the present disclosure will be described hereafter referring to drawings. In the embodiments, a part that corresponds to a matter described in a preceding embodiment may be assigned with the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

### First Embodiment

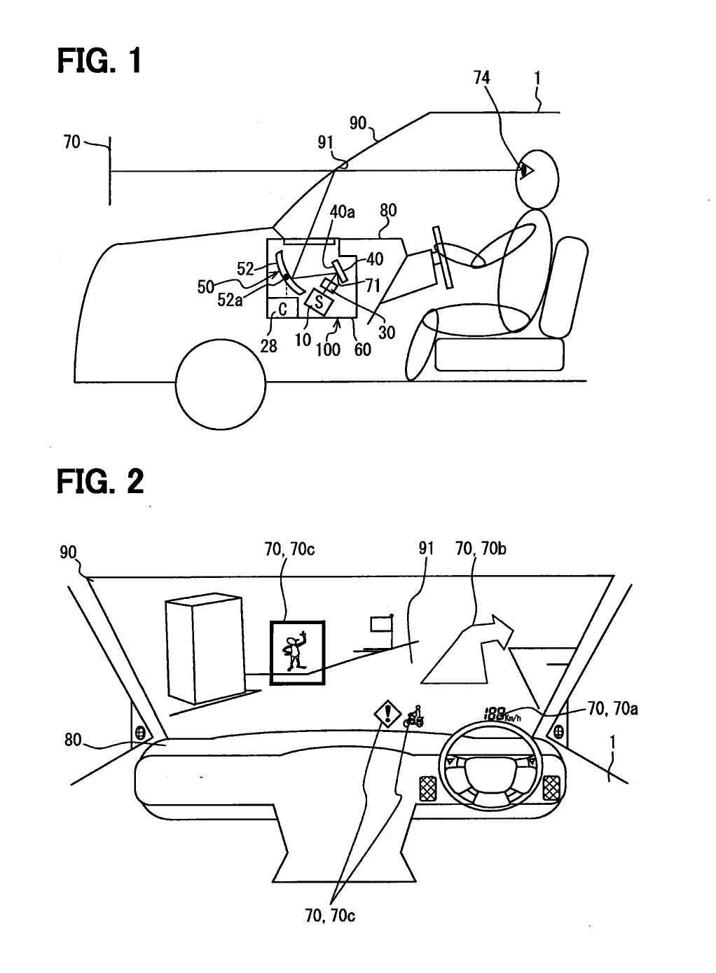

As shown in FIG. 1, a head-up display (HUD) device 100 according to a first embodiment is mounted on a vehicle 1 corresponding to a movable unit, and is accommodated in an instrument panel 80. The HUD device 100 projects a display picture 71 by laser light to a windshield 90 which is a display component of the vehicle 1. In the vehicle 1, the inner side surface of the windshield 90 corresponds to a projection surface 91 to which the display picture 71 is projected above the instrument panel 80 (see FIG. 2). In the vehicle 1, the inclination angle may be different between the inner side surface and the outer side surface of the windshield 90 so as to restrict an optical path difference. Alternatively, a vapor deposition membrane or a film may be disposed on the inner side surface so as to restrict the optical path difference.

When the display picture 71 is projected to the projection surface 91, in a passenger compartment of the vehicle 1, light flux reflected by the projection surface 91 reaches an eyepoint 74 of an occupant such as driver. When the light flux reaching the eyepoint 74 is perceived by the occupant, visual confirmation can be performed relative to a virtual image 70 of the display picture 71 formed as an image ahead of the windshield 90.

By projecting the display picture 71 to the projection surface 91, as shown in FIG. 2, the HUD device 100 displays the virtual image 70 of the display picture 71 so as to be recognized in the passenger compartment of the vehicle 1. The virtual image 70 includes, for example, an instruction display 70a of the speed of the vehicle 1, an instruction display 70b of the driving direction of the vehicle 1 by a navigation system and a warning display 70c as to the vehicle 1.

The HUD device 100 which displays the virtual image 70 is explained in detail below. As shown in FIG. 1, the HUD device 100 is equipped with a projector 10, a prism component 30, a screen component 40 and an optical system 50 which are received in a housing 60.

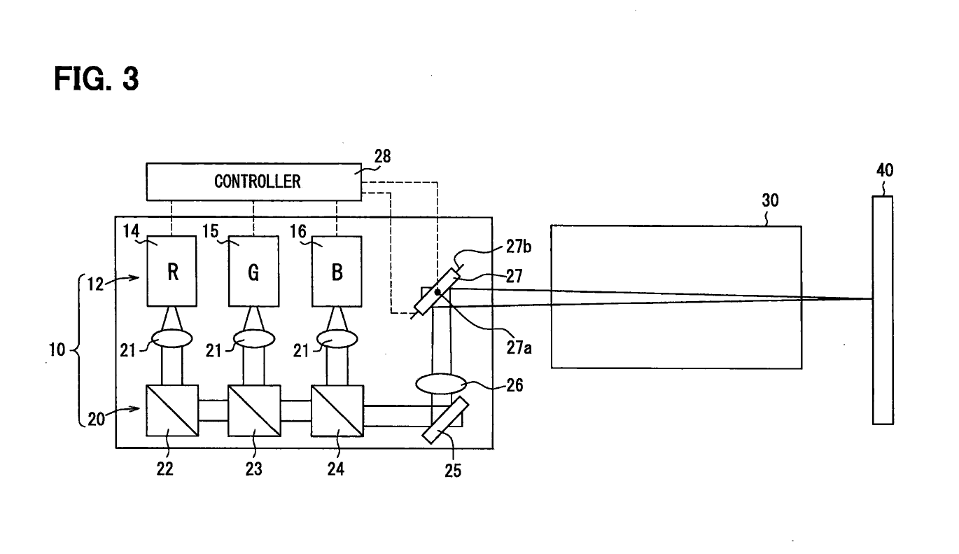

As shown in FIG. 3, the projector 10 has a light source part 12 and a light introducing part 20. The light source part 12 includes three laser emission parts, i.e., first laser emission part 14, second laser emission part 15 and third laser emission part 16. The respective laser emission parts 14, 15, 16 emit single wavelength laser light different from each other in the hue according to a control signal output from a controller 28.

Specifically, the first laser emission part 14 emits a red laser light having a peak wavelength of, for example, 640 nm or in a range of 600-650 nm. The second laser emission part 15 emits a green laser light having a peak wavelength of, for example, 515 nm or in a range of 490-530 nm. The third laser emission part 16 emits a blue laser light having a peak wavelength of, for example, 450 nm or in a range of 430-470 nm. A variety of colors can be produced by mixing the laser light having the three colors projected from the laser emission parts 14, 15, 16.

The light introducing part 20 has three collimator lenses 21, dichroic filters 22, 23, 24, a laser mirror 25, a light gathering lens 26, and a scanning mirror 27. Each of the collimator lenses 21 collimates the laser light output from the corresponding laser emission part 14, 15, 16 to parallel light by refraction action.

Each of the dichroic filters 22, 23, 24 reflects the laser light having a specific wavelength, of the laser lights which pass the corresponding collimator lens 21, and the other laser lights having the other wavelength pass through the dichroic filter 22, 23, 24. Specifically, the dichroic filter 22 arranged adjacent to the projection side of the laser emission part 14 reflects a red laser light, and the other color laser light passes through the dichroic filter 22. The dichroic filter 23 arranged adjacent to the projection side of the laser emission part 15 reflects a green laser light, and the other color laser light passes through the dichroic filter 23. The dichroic filter 24 arranged adjacent to the projection side of the laser emission part 16 reflects a blue laser light, and the other color laser light passes through the dichroic filter 24.

As mentioned above, in this embodiment, the red laser light reflected by the dichroic filter 22 and passing through the dichroic filter 24, the green laser light reflected by the dichroic filter 23 and passing through the dichroic filter 24, and the blue laser light reflected by the dichroic filter 24 are incident into the laser mirror 25.

The laser mirror 25 reflects the laser light having each color toward the light gathering lens 26. The light gathering lens 26 mixes the laser lights in the focused and concentrated state after reflected by the laser mirror 25. The mixed-color laser light is incident into the scanning mirror 27 from the light gathering lens 26, and the scanning mirror 27 projects the mixed-color laser light as light flux to be the display picture 71. The scanning mirror 27 has two rotation axes, i.e., first rotation axis 27a and second rotation axis 27b, and is rotatable at each of the first rotation axis 27a and the second rotation axis 27b. An actuator (not shown) of the scanning mirror 27 rotates the scanning mirror 27 at the two axes according to a drive signal output from the controller 28, so as to change the projection direction of laser light.

The controllers 28 has an electronic circuit such as microcomputer, for example. The controller 28 outputs a control signal to each of the laser emission parts 14, 15, 16, thereby intermittently performing pulse projection of the laser light. The controller 28 controls the projection direction of laser light by outputting a drive signal to the actuator of the scanning mirror 27.

The prism component 30 introduces the laser light projected from the projector 10, and irradiates the laser light to the screen component 40. At this time, the prism component 30 reflects the laser light inside, and works as lens such that image formation is made with the laser light to the screen component 40 in the spot state.

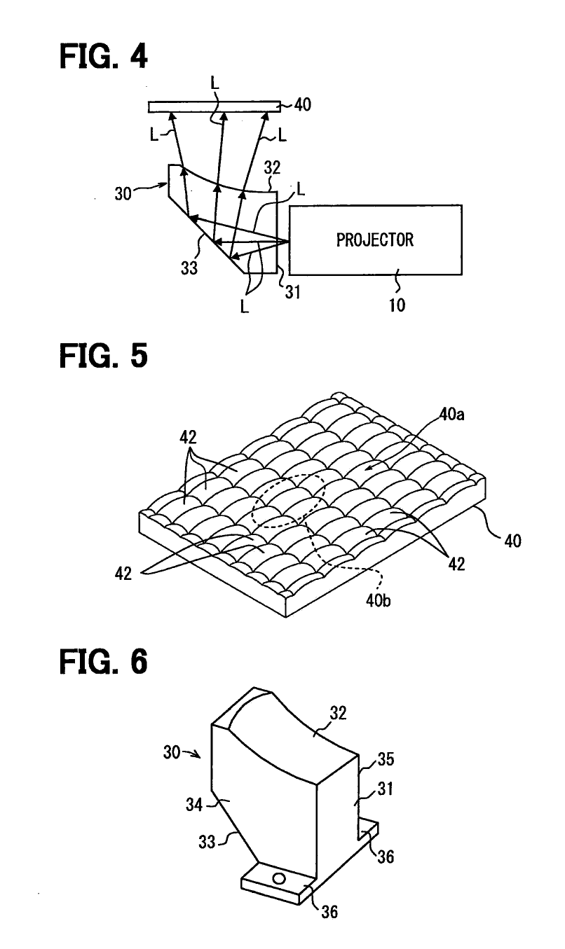

As shown in FIG. 4, the laser light which passes the prism component 30 has an optical path L between the projector 10 and the screen component 40. The optical path L is changed by the two-axis rotations of the scanning mirror 27, but all the optical paths in the variation range are referred as the optical path L between the projector 10 and the screen component 40 or just as the optical path L.

As shown in FIG. 1, the screen component 40 has an image-forming surface 40a. The laser light irradiated from the prism component 30 forms an image on the image-forming surface 40a. The screen component 40 diffuses the laser light by the reflex action on the image-forming surface 40a.

As shown in FIG. 5, the screen component 40 has plural optical elements 42 on the image-forming surface 40a as a micro mirror arranged in the array shape in the two dimensional direction. On the image-forming surface 40a where the laser light is irradiated in the spot state, at least one of the optical elements 42 is settled in an irradiation domain 40b having a predetermined spot size, and the irradiation domain 40b is scanned in the two dimensional direction according to the two-axis rotation of the scanning mirror 27. By such scanning operation, the display picture 71 is formed on the image-forming surface 40a.

As shown in FIG. 1, the optical system 50 has a concave mirror 52. The concave mirror 52 reflects the light flux of the display picture 71 diffused by the screen component 40 toward the projection surface 91. The concave mirror 52 is able to swing at a swinging axis 52a. An actuator (not shown) of the concave mirror 52 makes the concave mirror 52 to swing around the swinging axis 52a according to a drive signal output from the controller 28, so as to change the image-focused position of the virtual image 70 up and down.

Details of the prism component 30 are explained with reference to FIGS. 4 and 6. The prism component 30 has a block shape having approximately polyhedron shape and is made by a translucent material having a refractive index which is higher than that of air, such as transparent resin or translucent glass. The prism component 30 corresponds to an optical surface which exists on the optical path L between the projector 10 and the screen component 40, and is a single component integrally having the incidence surface 31, the exit surface 32, and the mirror surface 33.

As shown in FIG. 4, the incidence surface 31 has a plane shape which faces the projector 10 on the optical path L. Thereby, the laser light output from the projector 10 is incident into the incidence surface 31, and the incident light is led into the inside of the prism component 30. The exit surface 32 has a concave shape facing the screen component 40 on the optical path L and recessed away from the screen component 40. Thereby, the exit surface 32 which constructs a lens surface together with the incidence surface 31 emits laser light, and the emitted light forms an image on the screen component 40 in the spot state. The lens surface means an optical surface where light can be diffused or focused by refraction action, and may correspond to the incidence surface 31 and the exit surface 32.

The mirror surface 33 has a plane shape which faces aslant (not parallel) the incidence surface 31 and the exit surface 32 on the optical path L A reflective film such as an aluminum vapor deposition film is laminated on the outer side of the mirror surface 33. The laser light incident from the incidence surface 31 is reflected toward the exit surface 32 inside the screen component 40, and the optical path L is bent from the side of the incidence surface 31 to the side of the exit surface 32.

As shown in FIG. 6, the prism component 30 has a first side surface 34 and a second side surface 35, which are not the optical surface 31, 32, 33, and an attachment part 36 is formed on each of the first side surface 34 and the second side surface 35. The attachment part 36 has a plate shape projected outward from each of the first side surface 34 and the second side surface 35 to be approximately perpendicular to the incidence surface 31. The attachment part 36 is attached to a frame of the instrument panel 80 (see FIGS. 1 and 2) by a fastening member such as screw.

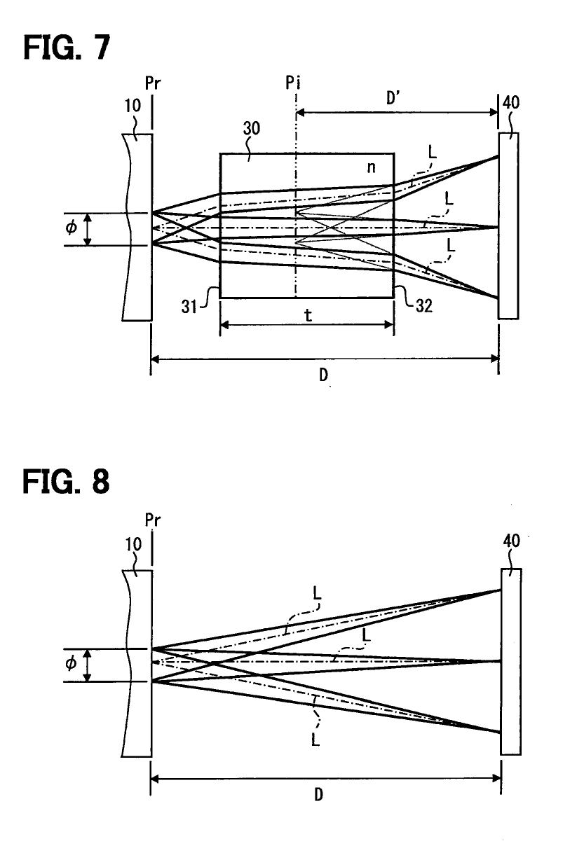

A numerical aperture between the projector 10 and the screen component 40 is explained with reference to FIGS. 7 and 8. FIG. 7 represents a case of the first embodiment in which the prism component 30 is provided, and FIG. 8 represents a case of comparative example in which the prism component 30 is not provided. In FIGS. 7 and 8, as to the three optical paths L which are changed according to the two-axis rotation of the scanning mirror 27, the image formation to the screen component 40 is illustrated typically. In FIG. 7, illustration of the reflection by the mirror surface 33 is omitted.

In the comparative example of FIG. 8, a numerical aperture NA is expressed by the following formula 1 where an actual distance between the projector 10 and the screen component 40 is defined as D, and where a projection diameter of the laser light projected from an actual projection position Pr of the projector 10 is defined as φ. In the present embodiment, the projection diameter φ corresponds to a beam diameter of the laser light at the reflection point by the scanning mirror 27 of FIG. 3.

NA=φ/2D formula 1

In the first embodiment with reference to FIG. 7, a numerical aperture NA is expressed by the following formula 2 where an air-conversion-length including the inside of the prism component 30 is defined as D′, and where a projection diameter of the laser light projected from an actual projection position Pr of the projector 10 is defined as φ. In the present embodiment, the air-conversion-length D′ corresponds to a distance from the screen component 40 to a virtual (apparent) projection position Pi. The air-conversion-length D′ is expressed by the following formula 3 where an actual distance between the incidence surface 31 and the exit surface 32 through the mirror surface 33 is defined as t, where the actual distance between the projector 10 and the screen component 40 is defined as D, and where a refractive index of the prism component 30 is defined as n.

Therefore, the numerical aperture NA in the first embodiment is expressed by the following formula 4 based on the formula 2 and the formula 3.

NA=φ/2D′ formula 2

D′=D−t·(1−1/n) formula 3

NA=φ{2D−2t·(1−1/n)} formula 4

Advantages in the first embodiment are explained below. On the optical path L between the projector 10 and the screen component 40, the prism component 30 which introduces the laser light from the projector 10 and irradiates the laser light to the screen component 40 integrally has the incidence surface 31 and the exit surface 32, each of which constructs a lens surface, and the mirror surface 33. Accordingly, the optical path L is bent by the reflex action by the mirror surface 33, so the size can be made smaller. Further, the image-forming performance can be raised by the image in the spot state made through the incidence surface 31 and the exit surface 32. The above advantages can be obtained by the prism component 30 which includes the mirror surface 33, the incidence surface 31 and the exit surface 32. The number of components to produce the head-up display device can be reduced, and the head-up display device can be easily and accurately mounted to the vehicle 1.

Furthermore, due to the prism component 30 which has the refractive index n which is higher than that of air, the laser light incident into the incidence surface 31 from the projector 10 is reflected by the mirror surface 33 inside the prism component 30, and is emitted toward the screen component 40 from the exit surface 32. Accordingly, relative the actual distance D between the projector 10 and the screen component 40, the air-conversion-length D′ through the prism component 30 is relatively shortened by the high refraction characteristic of the prism component 30. Thus, the numerical aperture NA between the projector 10 and the screen component 40 can be increased as much as possible. The increase in the numerical aperture NA may decrease the spot size of the laser light which is formed into the image on the screen component 40, so the resolution of the display picture 71 can be improved in the range according to the actual distance D between the projector 10 and the screen component 40.

In the first embodiment, inside the prism component 30 having the high refractive index n, the air-conversion-length D′ passing inside the prism component 30 can be shortened between the projector 10 and the screen component 40 by the actual distance t between the incidence surface 31 and the exit surface 32 via the mirror surface 33. Therefore, the numerical aperture NA expressed by the formula 4 using the projection diameter φ of laser light is increased in the range corresponding to the actual distance D between the projector 10 and the screen component 40. It becomes possible to improve the image formation performance certainly.

In the first embodiment, the portion of the prism component 30 other than the incidence surface 31, the exit surface 32, and the mirror surface 33 which are formed as the optical surface is attached to the vehicle 1 as the attachment part 36. Accordingly, high assemblability can be attained, without inhibiting the bending of the optical path L by the mirror surface 33 and the spot-state image formation by one of the incidence surface 31 and the exit surface 32.

### Second Embodiment

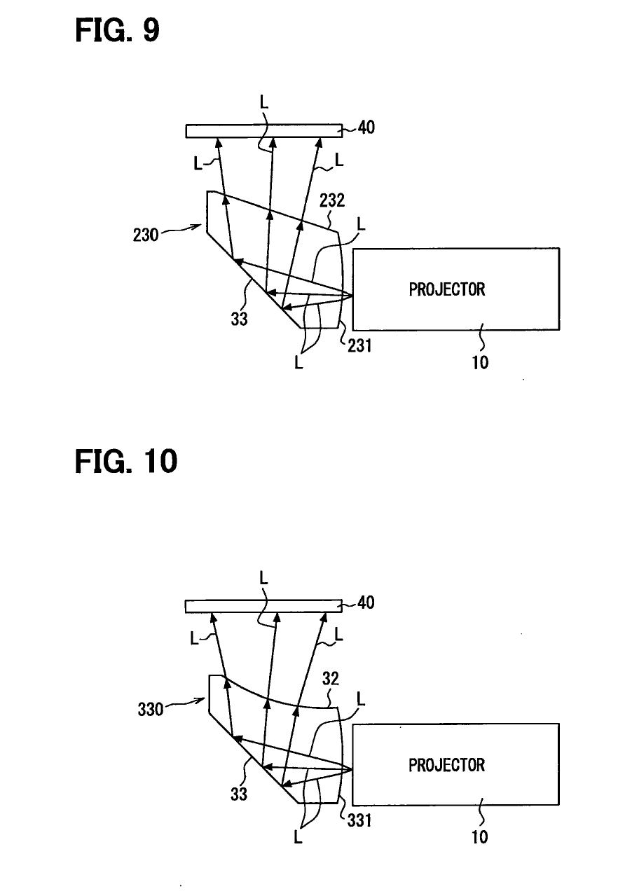

As shown in FIG. 9, a second embodiment is a modification of the first embodiment. A prism component 230 of the second embodiment has an exit surface 232 having a plane shape, and an incidence surface 231 having a convex shape projected toward the projector 10. The lens surface is constituted by the incidence surface 231 and the exit surface 232. According to the second embodiment, the image formation in the spot state through the incidence surface 231 raises the image formation performance, similarly to the first embodiment

### Third Embodiment

As shown in FIG. 10, a third embodiment is a modification of the first embodiment. A prism component 330 of the third embodiment has an incidence surface 331 having a convex shape projected toward the projector 10. The lens surface is constituted with the incidence surface 331 together with the concave-shaped exit surface 32. According to the third embodiment, the image formation in the spot state through the incidence surface 331 and the exit surface 32 raises the image formation performance, similarly to the first embodiment.

### Other Embodiment

The present disclosure is not limited to the above embodiments.

In a first modification about the first and third embodiments, the lens surface may be constructed by the exit surface 32 having the convex shape projected toward the screen component 40.

In a second modification about the second and third embodiments, the lens surface may be constructed by the incidence surface 231 recessed away from the projector 10 or the incidence surface 331 recessed away from the projector 10.

In a third modification about the first to third embodiments, the mirror surface 33 may have a concave shape recessed toward the incidence surface 31, 231, 331 or the exit surface 32, 232 or a convex shape projected away from the incidence surface 31, 231, 331 or the exit surface 32, 232.

In a fourth modification about the first to third embodiments, the mirror surface 33 may be a total-reflection-surface having no reflective film.

In a fifth modification about the first to third embodiments, the prism component 30, 230, 330 may have a plurality of the mirror surfaces 33 on the optical path L between the incidence surface 31, 231, 331 and the exit surface 32, 232.

In a sixth modification about the first to third embodiments, the attachment part 36 may be formed at a position different from the optical path L in either of the surfaces 31, 231, 331, 32, 232, 33 corresponding to the optical surface.

In a seventh modification about the first to third embodiments, the screen component 40 may be constituted in a manner that laser light may pass through each of the optical elements 42 corresponding to the micro lens. Alternatively, the screen component 40 may have no optical element 42.

In an eighth modification about the first to third embodiments, the display component having the projection surface 91 may be an element other than the windshield 90. For example, a combiner may be adopted which is fixed on the inner surface of the windshield 90 or produced separately from the windshield 90.

In a ninth modification about the first to third embodiments, the projector 10 may separately have a first scanning mirror rotated around the first rotation axis 27a and a second scanning mirror rotated around the second rotation axis 27b.

In a tenth modification about the first to third embodiments, other optical element may replace with the concave mirror 52, or the concave mirror 52 may be eliminated.

In an eleventh modification about the first to third embodiments, the present disclosure may be applied to various movable units (transport machine) such as vessel or airplane other than the vehicle 1.

Such changes and modifications are to be understood as being within the scope of the present disclosure as defined by the appended claims.

What is claimed is:

1. A head-up display device that projects a display picture on a projection surface of a movable unit to display a virtual image of the display picture which is seen from an interior of the movable unit, the head-up display device comprising:
a projector which projects laser light;
a screen component which produces the display picture to be projected on the projection surface by irradiating the laser light; and
a prism component disposed on an optical path between the projector and the screen component, the prism component introducing and irradiating the laser light projected from the projector to the screen component, wherein
the prism component has a refractive index which is higher than that of air, and integrally has
an incidence surface which the laser light enters from the projector,
a mirror surface which reflects the laser light entering inside the prism component from the incidence surface, and
an exit surface which emits the laser light reflected by the mirror surface toward the screen component outside of the prism component, as optical surface on the optical path, and
each of the incidence surface and the exit surface constructs a lens surface such that that the laser light is formed into an image relative to the screen component in a spot state.

2. The head-up display device according to claim 1, wherein
a numerical aperture between the projector and the screen component is defined as NA,
a projection diameter of the laser light projected by the projector is defined as φ,
an actual distance between the projector and the screen component is defined as D,
an actual distance between the incidence surface and the exit surface via the mirror surface inside of the prism component is defined as t,
a refractive index of the prism component is defined as n, and
a relationship of NA=φ/{2D−2t·(1−1/n)} is satisfied.
the prism component has an attachment part to be attached to the movable unit, and
the attachment part is formed at a portion of the prism component other than the optical surface.
